(19) United States
(12) Patent Application Publication
(10) Pub. No.: US 2021/0396284 A1
(43) Pub. Date: Dec. 23, 2021

(54) Airbrake Filter Assembly

(71) Applicant: Alex Prado, JR., Strathmore, CA (US)

(72) Inventor: Alex Prado, JR., Strathmore, CA (US)

(21) Appl. No.: 16/904,116

(22) Filed: Jun. 17, 2020

(51) Int. Cl. F16D 65/00; F16D 65/847

(52) U.S. Cl. CPC F16D 65/0031; F16D 55/22; F16D 65/847

(57) ABSTRACT

An airbrake filter assembly for reducing dust produced by air brakes on a vehicle includes a sock that is comprised of a fluid permeable material for passing air therethrough. The sock is positionable on a pressure release tube of an air brake system on a vehicle to slow the velocity of air being expelled from the pressure release tube. A cup is positioned in the sock and the cup is comprised of an air impermeable material to inhibit air from passing therethrough. The cup is aligned with the flow of air outwardly through the pressure release tube such that the cup directs the flow of air laterally through the sock. In this way the cup inhibits the flow of air from producing dust that would result if the air is blown onto the ground.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to filter device and more particularly pertains to a new filter device for reducing dust produced by air brakes on a vehicle.

### (2) Description of Related Art Including Information Disclosed Under 37 CFR 1.97 and 1.98

The prior art relates to filter devices including a sock that is positionable over an exhaust pipe of an engine for reducing noise. The prior art discloses an air dryer system for a commercial vehicle having a pair of desiccant canisters for drying air routed through the air dryer system. The prior art also discloses a desiccant cartridge for an air dryer system of a vehicle. The prior art discloses an air deflection disk that has air channels integrated therein for redirecting a downward flow of air from an air dryer system into a lateral direction for inhibiting the production of dust. The prior art discloses a variety of sound attenuation devices that are attached to an exhaust pipe of an engine.

### BRIEF SUMMARY OF THE INVENTION

An embodiment of the disclosure meets the needs presented above by generally comprising a sock that is comprised of a fluid permeable material for passing air therethrough. The sock is positionable on a pressure release tube of an air brake system on a vehicle to slow the velocity of air being expelled from the pressure release tube. A cup is positioned in the sock and the cup is comprised of an air impermeable material to inhibit air from passing therethrough. The cup is aligned with the flow of air outwardly through the pressure release tube such that the cup directs the flow of air laterally through the sock. In this way the cup inhibits the flow of air from producing dust that would result if the air is blown onto the ground.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective phantom view of an airbrake filter assembly according to an embodiment of the disclosure.

FIG. 2 is a bottom phantom view of an embodiment of the disclosure.

FIG. 3 is a perspective in-use view of an embodiment of the disclosure.

FIG. 4 is a cross sectional view taken along line 4-4 of FIG. 3 of an embodiment of the disclosure.

### DETAILED DESCRIPTION OF THE INVENTION

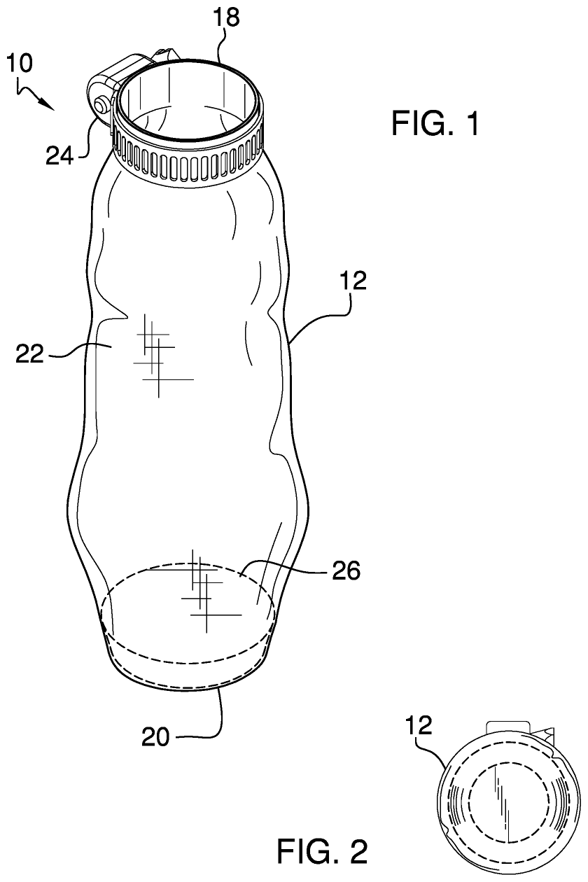

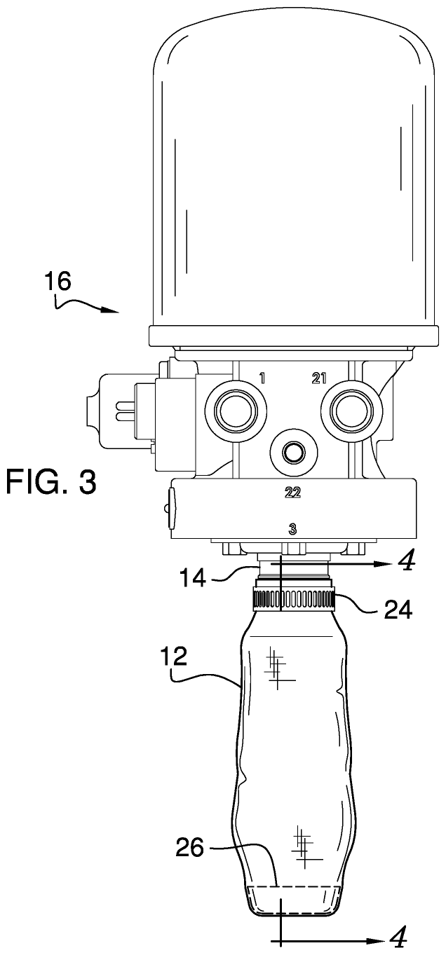

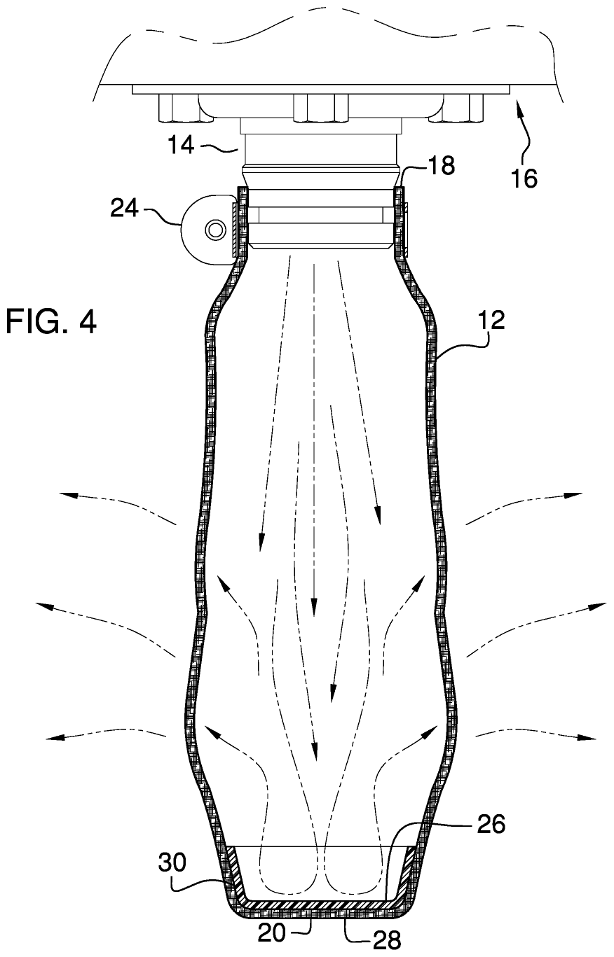

With reference now to the drawings, and in particular to FIGS. 1 through 4 thereof, a new filter device embodying the principles and concepts of an embodiment of the disclosure and generally designated by the reference numeral 10 will be described.

As best illustrated in FIGS. 1 through 4, the airbrake filter assembly 10 generally comprises a sock 12 that is comprised of a fluid permeable material to pass air therethrough. The sock 12 is positionable on a pressure release tube 14 of an air brake system 16 on a vehicle. In this way the sock 12 slows the velocity of air being expelled from the pressure release tube 14. The vehicle may be a cargo vehicle, such as a semi tractor, a dump truck or any other type of motorized vehicle that has an air brake system. Additionally, the pressure release tube 14 may be a component of an air dryer that is typically employed on air brake systems. The sock 12 has an upper end 18, a lower end 20 and an outer wall 22 extending therebetween, and the upper end 18 is open for insertably receiving the pressure release tube 14. The sock 12 may be comprised of an organic textile such as cotton, a synthetic textile such as nylon or any other type of fluid permeable and deformable material.

A clamp 24 is provided and the clamp 24 is coupled around the sock 12. The clamp 24 is tightenable around the pressure release tube 14 for retaining the sock 12 on the pressure release tube 14. The clamp 24 is positioned around the outer wall 22 of the sock 12 and the clamp 24 is aligned with the upper end 18 of the sock 12. The clamp 24 may comprise a hose clamp or any other type of releasable, mechanical clamp that forms a closed loop.

A cup 26 is provided and the cup 26 is positioned in the sock 12. The cup 26 is comprised of an air impermeable material to inhibit air from passing therethrough. Moreover, the cup 26 is aligned with the flow of air outwardly through the pressure release tube 14 such that the cup 26 directs the flow of air laterally through the sock 12. In this way the cup 26 inhibits the flow of air from producing dust from being blown on the ground. This is especially useful on agricultural vehicles that are commonly driven on dirt. Thus, the driver of the agricultural vehicle is not exposed to dust that enters the cab which would result from the air being blown downwardly onto the dirt.

The cup 26 has a bottom wall 28 and a perimeter wall 30 extending upwardly therefrom. The bottom wall 28 rests on the lower end 20 of the sock 12 and the perimeter wall 30 abuts the outer wall 22 of the sock 12. Additionally, the perimeter wall 30 extends upwardly along the outer wall 22 toward the upper end 18 of the sock 12. The cup 26 may be comprised of plastic, metal or any other rigid, fluid impermeable material.

In use, the upper end 18 of the sock 12 is positioned around the pressure release tube 14 and the clamp 24 is tightened around the pressure release tube 14. Thus, the cup 26 is spaced downwardly from the pressure release tube 14 such that the cup 26 is aligned with the flow of air that is released from the pressure release tube 14. Moreover, the cup 26 directs the air to flow laterally through the sock 12, thereby inhibiting the air from being blown downwardly onto the ground. In this way the sock 12 and the cup 26 inhibit the air from kicking up dust that would otherwise be produced by the air being blown outwardly from the pressure release tube 14. In this way the driver of the vehicle is inhibited from being exposed to dust that is typically produced by the air discharge from the pressure release tube 14.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An airbrake filter assembly for inhibiting an air discharge on an airbrake system from kicking up dust and debris, said assembly comprising:
a sock being comprised of a fluid permeable material wherein said sock is configured to pass air therethrough, said sock being positionable on a pressure release tube of an air brake system on a vehicle wherein said sock is configured to slow the velocity of air being expelled from the pressure release tube; and
a cup being positioned in said sock, said cup being comprised of an air impermeable material wherein said cup is configured to inhibit air from passing therethrough, said cup being aligned with the flow of air outwardly through the pressure release tube such that said cup directs the flow of air laterally through said sock wherein said cup is configured to inhibit the flow of air from producing dust that would result from being blown onto the ground.

2. The assembly according to claim 1, wherein:
said sock has an upper end, a lower end and an outer wall extending therebetween, said upper being open for insertably receiving the pressure release tube; and
said assembly includes a clamp being coupled around said sock, said clamp being tightenable around the pressure release tube for retaining said sock on the pressure release tube, said clamp being positioned around said outer wall of said sock, said clamp being aligned with said upper end of said sock.

3. The assembly according to claim 1, wherein:
said sock has an upper end, a lower end and an outer wall extending therebetween;
said cup has a bottom wall and a perimeter wall extending upwardly therefrom, said bottom wall resting on said lower end of said sock.

4. The assembly according to claim 3, wherein said perimeter wall abuts said outer wall of said sock, said perimeter wall extending upwardly along said outer wall toward said upper end of said sock.

5. An airbrake filter assembly for inhibiting an air discharge on an airbrake system from kicking up dust and debris, said assembly comprising:
a sock being comprised of a fluid permeable material wherein said sock is configured to pass air therethrough, said sock being positionable on a pressure release tube of an air brake system on a vehicle wherein said sock is configured to slow the velocity of air being expelled from the pressure release tube, said sock having an upper end, a lower end and an outer wall extending therebetween, said upper being open for insertably receiving the pressure release tube;
a clamp being coupled around said sock, said clamp being tightenable around the pressure release tube for retaining said sock on the pressure release tube, said clamp being positioned around said outer wall of said sock, said clamp being aligned with said upper end of said sock; and
a cup being positioned in said sock, said cup being comprised of an air impermeable material wherein said cup is configured to inhibit air from passing therethrough, said cup being aligned with the flow of air outwardly through the pressure release tube such that said cup directs the flow of air laterally through said sock wherein said cup is configured to inhibit the flow of air from producing dust that would result from being blown onto the ground, said cup having a bottom wall and a perimeter wall extending upwardly therefrom, said bottom wall resting on said lower end of said sock, said perimeter wall abutting said outer wall of said sock, said perimeter wall extending upwardly along said outer wall toward said upper end of said sock.

6. An airbrake filter system for inhibiting an air discharge on an airbrake system from kicking up dust and debris, said system comprising:
a vehicle having an air brake system, said air brake system including a pressure release tube wherein said pressure release tube is configured to release compressed air downwardly toward the ground;
a sock being comprised of a fluid permeable material wherein said sock is configured to pass air therethrough, said sock being positionable on said pressure release tube wherein said sock is configured to slow the velocity of air being expelled from said pressure release tube, said sock having an upper end, a lower end and an outer wall extending therebetween, said upper being open for insertably receiving said pressure release tube;
a clamp being coupled around said sock, said clamp being tightenable around said pressure release tube for retaining said sock on said pressure release tube, said clamp being positioned around said outer wall of said sock, said clamp being aligned with said upper end of said sock; and
a cup being positioned in said sock, said cup being comprised of an air impermeable material wherein said cup is configured to inhibit air from passing therethrough, said cup being aligned with the flow of air outwardly through said pressure release tube such that said cup directs the flow of air laterally through said sock wherein said cup is configured to inhibit the flow of air from producing dust when the air is blown on the ground, said cup having a bottom wall and a perimeter wall extending upwardly therefrom, said bottom wall resting on said lower end of said sock, said perimeter wall abutting said outer wall of said sock, said perimeter wall extending upwardly along said outer wall toward said upper end of said sock.
